(19) United States
(12) Patent Application Publication
(10) Pub. No.: US 2023/0275345 A1
(43) Pub. Date: Aug. 31, 2023

(54) Electronic Device

(71) Applicant: Huawei Technologies Co., Ltd., Shenzhen (CN)

(72) Inventors: Tiezhu Liang, Shenzhen (CN); Chao Feng, Shenzhen (CN); Dawei Zhou, Shenzhen (CN)

(21) Appl. No.: 18/007,953

(22) PCT Filed: May 18, 2021
(86) PCT No.: PCT/CN2021/094443

§ 371 Date: Dec. 2, 2022

(30) Foreign Application Priority Data
Jun. 4, 2020 (CN) 202010498946.0

(51) Int. Cl. H01Q 1/50; H01Q 5/335; H01Q 1/24; H01Q 1/36; H01Q 1/48; H01Q 5/328

(52) U.S. Cl. CPC H01Q 1/50; H01Q 5/335; H01Q 1/243; H01Q 1/36; H01Q 1/48; H01Q 5/328

(57) ABSTRACT

An electronic device includes a metal frame, a feed unit, a switch, a matching network, and a first radiator. The first radiator is part of the metal frame and disposed along two adjacent edges of the electronic device, where a feed point of the first radiator is disposed in a junction area of two adjacent edges of the metal frame, and the feed unit feeds the first radiator at the feed point. The first radiator is configured with a first ground point located between the feed point and a first end of the first radiator, and the first radiator is grounded at the first ground point. The first radiator is configured with a second ground point located between the feed point and a second end of the first radiator. The switch is electrically coupled between the second ground point and the matching network.

This application claims priority to Chinese Patent Application No. 202010498946.0, filed with the China National Intellectual Property Administration on Jun. 4, 2020 and entitled “ELECTRONIC DEVICE”, which is incorporated herein by reference in its entirety.

### TECHNICAL FIELD

This application pertains to the field of radio communications, and in particular, relates to an electronic device.

### BACKGROUND

In the past, since a conventional second generation (second generation, 2G) mobile communication system mainly supported a call function, an electronic device was only a tool used by people to send and receive short messages and perform voice communication, and a wireless network access function was extremely slow because data was transmitted through a voice channel.

Today, with rapid development of wireless communications technologies, a fifth generation (fifth generation, 5G) mobile communications system comes. This leads to an increasing quantity of antennas and frequency bands, and an increasingly high data transmission speed. However, space provided for an antenna is increasingly limited while the electronic device develops toward a direction of a large screen and a plurality of cameras. Especially, because a low-frequency antenna requires a relatively large physical size, a great challenge to antenna design is caused.

### SUMMARY

Embodiments of this application provide an electronic device. The electronic device may include an antenna structure. In the antenna structure, a feed point is disposed to adjust a transverse mode and a longitudinal mode generated by the antenna structure. The two modes can be used to effectively improve antenna radiation performance in a beside head and hand model.

According to a first aspect, an electronic device is provided, including: a first radiator, a feed unit, a switch, and a matching network. The first radiator is disposed along two adjacent edges of the electronic device, the first radiator is configured with a feed point, the feed point is located in a central area of the first radiator, and the feed unit feeds at the feed point. The first radiator is configured with a first ground point, the first ground point is located between the feed point and a first end of the first radiator, and the first radiator is grounded at the first ground point. The first radiator is configured with a second ground point, and the second ground point is located between the feed point and a second end of the first radiator. One end of the switch is electrically connected to the first radiator at the second ground point, and the other end of the switch is electrically connected to the matching network.

According to the technical solutions of embodiments of this application, the first radiator is disposed along two edges of the electronic device, and in free space, a resonance may be generated by using a radiator between the feed point and the second ground point. In a case of a beside head and hand, radiation may be generated by using a radiator between the feed point and the first end, so that impact of the beside head and hand model on radiation performance of the antenna structure can be reduced. In addition, the switch may be configured to correspondingly switch different types of matching in the matching network when the antenna structure works in different frequency bands. Specifically, the switch changes a current mode on the first radiator by switching the different types of matching in the matching network, to change an operating frequency of the antenna structure. In addition, the switch can also be used to balance radiation performance of the antenna structure in free space and an amplitude decrease in the beside head and hand model.

With reference to the first aspect, in some implementations of the first aspect, a distance between the feed point and the second ground point is a quarter of a wavelength corresponding to a resonance point of a resonance generated by the first radiator.

According to the technical solutions in embodiments of this application, the radiator between the feed point and the second ground point may work in a quarter-wavelength mode.

With reference to the first aspect, in some implementations of the first aspect, when the feed unit is feeding, a frequency band corresponding to a resonance generated by the first radiator covers 698 MHz to 960 MHz.

According to the technical solutions in embodiments of this application, when the feed unit is feeding, the antenna structure may generate a first resonance, and correspondingly, an operating frequency band of the antenna structure may cover 698 MHz to 960 MHz, which may include a B5 frequency band (824 MHz to 849 MHz), a B8 frequency band (890 MHz to 915 MHz), and a B28 frequency band (704 MHz to 747 MHz) in a long term evolution system.

With reference to the first aspect, in some implementations of the first aspect, a length of the first radiator is greater than a quarter of a wavelength corresponding to a resonance point of the resonance and is less than a half of the wavelength corresponding to the resonance point of the resonance.

According to the technical solutions in embodiments of this application, a radiator between the feed point and the second end of the first radiator may be configured to increase a radiation aperture of the antenna structure, to improve radiation efficiency. In addition, when the antenna structure is disposed in a beside head and hand model, because the antenna structure is held by a hand, and a bottom gap is blocked, a radiation characteristic of the antenna structure is changed. The first resonance covering a low frequency band may be generated by the radiator between the feed point and the second end of the first radiator, so that impact of the beside head and hand model on radiation performance of the antenna structure can be reduced, and overall radiation performance of the antenna structure can be improved.

With reference to the first aspect, in some implementations of the first aspect, the first radiator is a metal frame of the electronic device.

According to the technical solutions in embodiments of this application, the antenna structure formed by the first radiator may be a flexible circuit board or a mode decoration antenna, may be disposed along any two adjacent edges of the electronic device, and may be disposed at a boundary of the two edges. Alternatively, the antenna structure may be a metal-frame antenna, and the first radiator may be a part of a metal frame of the electronic device.

With reference to the first aspect, in some implementations of the first aspect, the feed point is disposed in a junction area on two adjacent edges of the metal frame.

According to the technical solutions in embodiments of this application, when the antenna structure works in a longitudinal mode, a direction of maximum radiation of the antenna structure is parallel to a bottom edge of the electronic device. When a user uses a mobile phone, in a hand holding model, the maximum radiation of the antenna structure is absorbed by a hand, and a radiation performance loss of the antenna structure is large. When the antenna structure works in a transverse mode, a direction of maximum radiation of the antenna structure is perpendicular to the bottom edge of the electronic device. When the user uses the mobile phone, in a hand holding model, the maximum radiation of the antenna structure is not absorbed by a hand, and a radiation performance loss of the antenna structure is small, so that antenna radiation performance in a beside head and hand model can be effectively improved. Optionally, a proportion of the transverse mode generated by the antenna structure may be adjusted by adjusting a location of the first radiator or a location of the feed point, and the transverse mode may be used to optimize antenna radiation performance in a beside head and hand model, to improve performance in free space.

With reference to the first aspect, in some implementations of the first aspect, the first radiator is disposed on a side edge and a bottom edge of the metal frame of the electronic device, the first end of the first radiator is disposed on the side edge, and the second end of the first radiator is disposed on the bottom edge.

According to the technical solutions of embodiments of this application, the first radiator may be disposed along two adjacent edges of the electronic device, and the feed unit, the switch, and the matching network in the antenna structure may be disposed by using a circuit board that is inside the electronic device and that is close to the bottom edge.

With reference to the first aspect, in some implementations of the first aspect, the feed point is a center of gravity of the first radiator. With reference to the first aspect, in some implementations of the first aspect, an electrical length between the feed point and the first ground point is the same as an electrical length between the feed point and the second ground point.

According to the technical solutions in embodiments of this application, an electronic component may be grounded at the first ground point to adjust the electrical length between the feed point and the first ground point, and the electrical length between the feed point and the second ground point may be adjusted by adjusting matching in the matching network.

With reference to the first aspect, in some implementations of the first aspect, the electronic device further includes a second radiator. The second radiator is disposed on a side of the first radiator, and a gap is formed between the second radiator and the first radiator.

According to the technical solutions of embodiments of this application, the antenna structure includes the second radiator, and the second radiator may be disposed on any side of the first radiator. In this case, the gap is formed between the second radiator and the first radiator, so that the second radiator can generate a resonance through coupled feeding. This can expand an operating bandwidth of the antenna structure and improve performance in free space.

With reference to the first aspect, in some implementations of the first aspect, the second radiator is configured with a third ground point. The third ground point is disposed on an end that is of the second radiator and that is close to the first radiator, and the second radiator is grounded at the third ground point.

According to the technical solutions in embodiments of this application, because the second radiator is grounded at the third ground point, a length of the second radiator may be reduced to a quarter of a wavelength corresponding to a resonance point of a second resonance. This can effectively reduce a size of the second radiator.

### BRIEF DESCRIPTION OF DRAWINGS

FIG. 1 is a schematic diagram of an electronic device according to an embodiment of this application:

FIG. 2 is a schematic diagram of an antenna structure according to an embodiment of this application:

FIG. 3 is a schematic simulation diagram of radiation performance of the antenna structure shown in FIG. 2;

FIG. 4 is a schematic diagram of another antenna structure according to an embodiment of this application:

FIG. 5 is a schematic diagram of a structure of an electronic device according to an embodiment of this application:

FIG. 6 is a schematic diagram of a matching network according to an embodiment of this application;

FIG. 7 is a distribution diagram of currents when an antenna structure works in a B28 frequency band;

FIG. 8 is a distribution diagram of currents when an antenna structure works in a B5 frequency band;

FIG. 9 is a distribution diagram of currents when an antenna structure works in a B5 frequency band;

FIG. 10 is a schematic simulation diagram of system efficiency and S parameters in a beside head and hand model according to an embodiment of this application;

FIG. 11 is a schematic simulation diagram of system efficiency in a beside head and hand model according to an embodiment of this application; and

FIG. 12 is a Smith chart in a beside head and hand model according to an embodiment of this application.

### DESCRIPTION OF EMBODIMENTS

The following describes technical solutions of this application with reference to accompanying drawings.

An electronic device in embodiments of this application may be a mobile phone, a tablet computer, a notebook computer, a smart band, a smartwatch, a smart helmet, smart glasses, or the like. Alternatively, the electronic device may be a cellular phone, a cordless phone, a session initiation protocol (session initiation protocol, SIP) phone, a wireless local loop (wireless local loop, WLL) station, a personal digital assistant (personal digital assistant, PDA), a handheld device with a wireless communication function, a computing device or another processing device connected to a wireless modem, a vehicle-mounted device, a terminal device in a 5G network, a terminal device in a future evolved public land mobile network (public land mobile network, PLMN), or the like. This is not limited in this embodiment of this application.

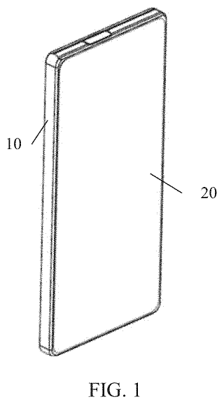

FIG. 1 is a schematic diagram of an electronic device according to an embodiment of this application. An example in which the electronic device is a mobile phone is used for description herein.

As shown in FIG. 1, the electronic device has a shape similar to a cube, and may include a frame 10 and a display 20. Both the frame 10 and the display 20 may be mounted on a middle frame (not shown in the figure). The frame 10 may be divided into an upper frame, a lower frame, a left frame, and a right frame. These frames are connected to each other, and may form a certain radian or chamfer at a connecting position.

The electronic device further includes a printed circuit board (printed circuit board, PCB) disposed inside. An electronic element may be disposed on the PCB. The electronic element may include a capacitor, an inductor, a resistor, a processor, a camera, a flash, a microphone, a battery, or the like, but is not limited thereto.

The frame 10 may be a metal frame made of metals such as copper, a magnesium alloy, or stainless steel, or may be a plastic frame, a glass frame, a ceramic frame, or the like, or may be a frame combining metal and plastic.

In recent years, mobile communication becomes increasingly important in life of people. Especially, as a fifth generation (fifth generation, 5G) mobile communications system era comes, a requirement for an antenna is increasingly high. A volume provided for an antenna in an electronic device is limited. Especially, because a low-frequency antenna requires a relatively large physical size, a difficulty is caused, for example, a great challenge to antenna design is caused.

In the 5G era, a low-frequency antenna of an electronic device brings main challenges in antenna design: how to improve efficiency in free space in a small size as much as possible; how to reduce impact of a beside head and hand model; and how to implement a wider antenna bandwidth to meet full-frequency band coverage.

Embodiments of this application provide a design solution of an antenna structure. A feed point is disposed to adjust a transverse mode and a longitudinal mode generated by the antenna structure. The two modes can be used to effectively improve antenna radiation performance in a beside head and hand model.

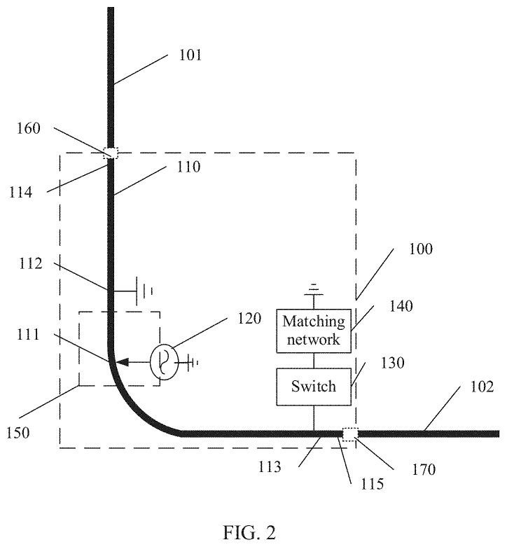

FIG. 2 is a schematic diagram of an antenna structure according to an embodiment of this application. The antenna structure may be applied to the electronic device shown in FIG. 1.

As shown in FIG. 2, the electronic device may include a first radiator 110 and a feed unit 120.

The first radiator 110 may be disposed along two adjacent edges of the electronic device. The first radiator 110 is configured with a feed point 111, a first ground point 112, and a second ground point 113, to form the antenna structure 100. The feed point 111 is located in a central area 150 of the first radiator 110, and the feed unit 120 feeds the antenna structure 100 at the feed point 111. The first ground point 112 is located between the feed point 111 and a first end 114 of the first radiator 110, and the first radiator 110 is grounded at the first ground point 112. The second ground point 113 is located between the feed point 111 and a second end 115 of the first radiator 110. One end of a switch 130 is electrically connected to the first radiator 110 at the second ground point 113, and the other end of the switch 130 is electrically connected to a matching network 140.

The switch 130 may be configured to correspondingly switch different types of matching in the matching network 140 when the antenna structure 100 works in different frequency bands. Specifically, the switch 130 changes a current mode on the first radiator by switching the different types of matching in the matching network, to change an operating frequency of the antenna structure 100. In addition, the switch can also be used to balance radiation performance of the antenna structure in free space and an amplitude decrease in a beside head and hand (beside head and hand, BHH) mode.

It should be understood that the central area 150 of the first radiator 110 may refer to an area around a geometric center of the first radiator 110. In addition, the first end 114 of the first radiator 110 may be a segment on the first radiator 110 from an endpoint, but not a point. The second end 112 of the first radiator 110 may also be accordingly understood as the foregoing concept.

Optionally, the first radiator 110 may be disposed along a side edge 101 and a bottom edge 102 of the electronic device. The antenna structure 100 may be a flexible circuit board (flexible printed circuit, FPC) or a mode decoration antenna (mode decoration antenna, MDA), may be disposed along any two adjacent edges of the electronic device, and may be disposed at a boundary of the two edges. Alternatively, the antenna structure 100 may be a metal-frame antenna, and the first radiator 110 may be a part of the metal frame of the electronic device. In this embodiment of this application, an example in which the antenna structure 100 is a metal-frame antenna is used for description, but an application manner of the antenna structure provided in this embodiment of this application is not limited.

Optionally, to ensure radiation performance of the antenna structure 100, a side gap 160 may be formed between the first radiator 110 and the side edge 101 of the frame, and a bottom gap 170 may be formed between the first radiator 110 and the bottom edge 102 of the frame. The side gap 160 and the bottom gap 170 may be filled with an insulation material, to ensure structural strength of the frame of the electronic device.

Optionally, the second ground point 113 may be located at any location between the feed point 111 and the second end 115 of the first radiator 110, and an electrical length between the feed point 111 and the second ground point may be adjusted by adjusting matching in the matching network 140.

It should be understood that an electrical length may be represented by a ratio of a physical length (that is, a mechanical length or a geometric length) multiplied by a transmission time (time a) of an electrical or electromagnetic signal in a medium to a time (time b) required for the signal to pass through a distance that is in free space and that is the same as a physical length of the medium. Alternatively, the electrical length may be a ratio of a physical length (that is, a mechanical length or a geometric length) to a wavelength of a transmitted electromagnetic wave.

Optionally, when the feed unit 120 is feeding, the antenna structure 100 may generate a first resonance, and correspondingly, an operating frequency band of the antenna structure 100 may cover 698 MHz to 960 MHz, which may include a B5 frequency band (824 MHz to 849 MHz), a B8 frequency band (890 MHz to 915 MHz), and a B28 frequency band (704 MHz to 747 MHz) in a long term evolution (long term evolution, LTE) system.

Optionally, a distance between the feed point 111 and the second ground point 113 along a surface of the first radiator 110 may be a quarter of a wavelength corresponding to a resonance point of a first resonance. It should be understood that the resonance point of the first resonance generated by the first radiator may be a resonance point of a generated resonance, or may be a center frequency of an operating frequency band.

It should be understood that, when the antenna structure 100 is disposed in free space (free space, FS), the first resonance is generated by a radiator between the feed point 111 and the second ground point 113, and different types of matching may be switched by using the switch 130 to change an operating frequency band corresponding to the first resonance generated by the antenna structure 100.

Optionally, a length of the first radiator 110 may be greater than a quarter of the wavelength corresponding to the resonance point of the first resonance and less than a half of the wavelength corresponding to the resonance point of the first resonance.

Optionally, the feed point may be a center of gravity of the first radiator 110, and a length of the first radiator 110 may be evenly divided, that is, electrical lengths of the first radiator 110 on two sides of the feed point 111 are the same. That the electrical lengths of the first radiator 110 on the two sides of the feed point are the same may be understood as that an electrical length between the feed point 111 and the first ground point 112 is the same as an electrical length between the feed point 111 and the second ground point 113.

It should be understood that a radiator between the feed point 111 and the second end 114 may be configured to increase a radiation aperture of the antenna structure 100, to improve radiation efficiency. In addition, when the antenna structure 100 is disposed in a beside head and hand model, because the antenna structure 100 is held by a hand, and the bottom gap 170 is blocked, a radiation characteristic of the antenna structure 100 is changed. The first resonance may be generated by the radiator between the feed point 111 and the second end 114, which can reduce impact of the beside head and hand model on radiation performance of the antenna structure 100.

According to the antenna structure provided in embodiments of this application, a location of a radiator that generates radiation may be changed based on different cases of hand holding by a user, to reduce impact of the hand holding by the user on radiation performance of the antenna structure 100.

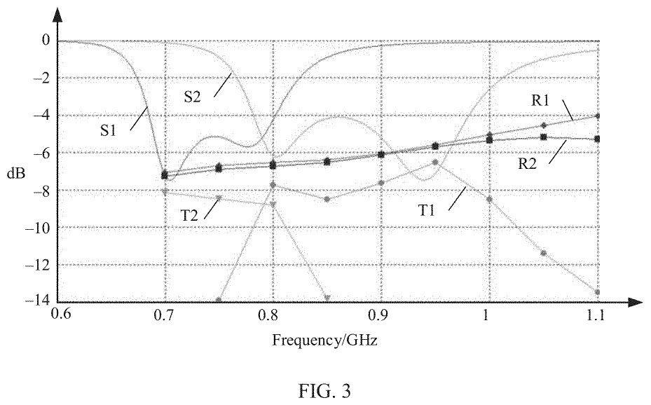

FIG. 3 is a schematic simulation diagram of radiation performance of the antenna structure shown in FIG. 2.

It should be understood that in the antenna structure, different types of matching may be switched by using a switch, to change an operating frequency band of the antenna structure. For brevity of description, embodiments of this application describe only two types of matching, but does not limit a quantity of types and a form of switching matching by using a switch.

As shown in FIG. 3, the switch switches corresponding S parameters, radiation efficiency (radiation efficiency) and system efficiency (total efficiency) when the two types of matching are performed. As shown in S1 and S2 in FIG. 3, when the antenna structure switches between different types of matching, the B28 (704 MHz to 747 MHz), the B5 (824 MHz to 849 MHz), and the B8 (890 MHz to 915 MHz) in the LTE system may be covered. In addition, radiation efficiency and system efficiency in a corresponding operating frequency band can also meet a requirement.

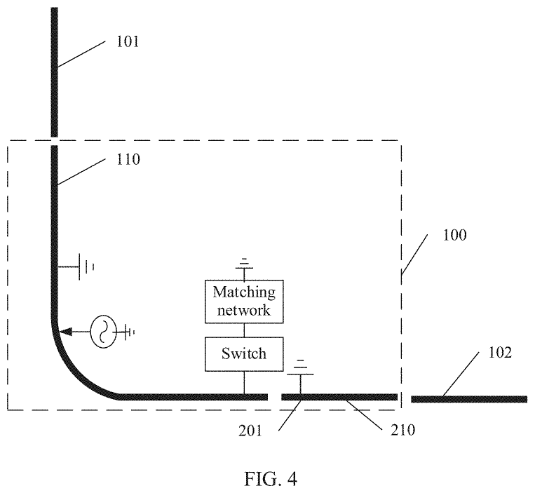

FIG. 4 is a schematic diagram of another antenna structure according to an embodiment of this application.

As shown in FIG. 4, the electronic device may further include a second radiator 210.

The second radiator 210 may be disposed on a side of the first radiator 110, and a gap is formed between the second radiator 210 and the first radiator 110.

Optionally, when the first radiator 110 is a metal frame, the second radiator 210 may also be a metal frame. The second radiator 210 may be disposed on the side edge 101 of the electronic device frame, and form a side gap with the first radiator 110, or may be disposed on the bottom edge 102 of the electronic device frame, and form a bottom gap with the first radiator 110. For brevity of description, in this embodiment of this application, an example in which the second radiator 210 is disposed on the bottom edge 102 is merely used for description, but a location of the second radiator 210 is not limited.

Optionally, when the antenna structure is an FPC antenna, a second radiator 210 may also be included.

Optionally, the second radiator 210 may be configured with a third ground point 201, the third ground point 201 may be disposed at an end that is of the second radiator and that is close to the first radiator, and the second radiator 210 may be grounded at the third ground point 201.

Optionally, when the feed unit 120 is feeding, the second radiator 210 may generate a second resonance. Because the second radiator 210 is grounded at the third ground point 201, a length of the second radiator 210 may be reduced to a quarter of a wavelength corresponding to a resonance point of the second resonance.

It should be understood that, because the antenna structure includes the second radiator, coupled feeding is performed on the second radiator by using the first radiator, to generate a resonance. In this way, an operating bandwidth of the antenna structure can be expanded, and performance in free space can be improved.

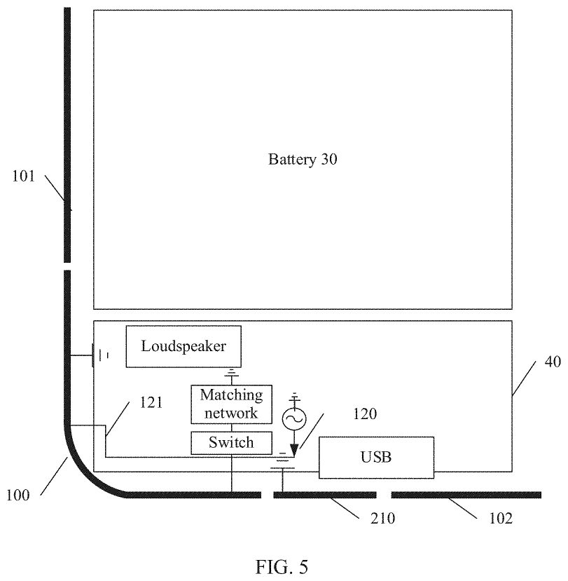

FIG. 5 is a schematic diagram of a structure of an electronic device according to an embodiment of this application.

As shown in FIG. 5, the electronic device may further include a battery 30 and a PCB 40. The battery 30 may be disposed close to the side edge 101, and the PCB 40 may be disposed close to the bottom edge 102.

Optionally, a loudspeaker and a universal serial bus (universal serial bus, USB) may be disposed on the PCB 40.

Optionally, a feed point may be disposed in a junction area of two adjacent frames, that is, a connecting position of the frames of the electronic device, which may be a chamfer or an arc area.

Optionally, the feed unit 120 may be disposed on the PCB 40. According to actual design and production requirements, the feed unit 120 may be disposed near the USB, and feed the antenna structure 100 at the feed point by using a metal wire segment 121.

It should be understood that a conventional low-frequency antenna is usually disposed on the side edge 101 close to the battery 30. However, because no PCB is disposed between the battery 30 and the side edge 101, additional cabling for feeding is usually required, and large space is required. The antenna structure 100 provided in embodiments of this application may be disposed along the two adjacent edges of the electronic device, to implement an electrical connection between the feed unit and the first radiator and arrangement of the switch and the matching network.

FIG. 6 is a schematic diagram of a matching network according to an embodiment of this application.

As shown in FIG. 6, the matching network may include a first capacitor 301 and a second capacitor 302. The switch 130 performs switching between the first capacitor 301 and the second capacitor 302, so that an antenna structure works in a corresponding frequency band.

Optionally, a capacitance value of the first capacitor 301 may be 1.5 pF, and a capacitance value of the second capacitor 302 may be 0.5 pF.

Optionally, when the switch 130 is connected to the first capacitor 301, an operating frequency band of the antenna structure may cover the B28 frequency band (704 MHz to 747 MHz) and the B5 frequency band (824 MHz to 849 MHz) in the LTE system. When the switch 130 is connected to the second capacitor 302, an operating frequency band of the antenna structure may cover the B5 frequency band (824 MHz to 849 MHz) and the B8 frequency band (890 MHz to 915 MHz) in the LTE system.

Optionally, a third capacitor 303 may be further configured between the third ground point 201 and ground, and a capacitance value of the third capacitor 303 may be 1.6 pF.

Optionally, a matching network may be added between the feed unit 120 and the feed point 111 of the first radiator 110, so that an electrical signal in the feed unit can match a characteristic of the radiator, to minimize a transmission loss and distortion of the electrical signal. This embodiment of this application provides only an example of a matching network, and does not limit a specific form of the matching network.

Optionally, a matching network between the feed unit 120 and the feed point 111 may include a fourth capacitor 304 and a fifth capacitor 305 that are sequentially connected in series, and a first inductor 306 may be connected in parallel between the feed point 111 and the fourth capacitor 304. Because a low-frequency band in the LTE system is wide, to ensure a good radiation characteristic of the antenna structure, a switch 310 may be connected in parallel between the fourth capacitor 304 and the fifth capacitor 305, and the switch 310 may perform switching between a second inductor 307 and a third inductor 308.

Optionally, when the switch 310 is connected to the second inductor 307, an operating frequency band of the antenna structure may cover the B28 frequency band (704 MHz to 747 MHz) and the B5 frequency band (824 MHz to 849 MHz) in the LTE system. When the switch 130 is connected to the third inductor 308, an operating frequency band of the antenna structure may cover the B5 frequency band (824 MHz to 849 MHz) and the B8 frequency band (890 MHz to 915 MHz) in the LTE system.

Optionally, a capacitance value of the fourth capacitor 304 may be 2 pF, a capacitance value of the fifth capacitor 305 may be 1.8 pF, an inductance value of the first inductor 306 may be 20 nH, an inductance value of the second inductor 307 may be 12 nH, and an inductance value of the third inductor 308 may be 9 nH.

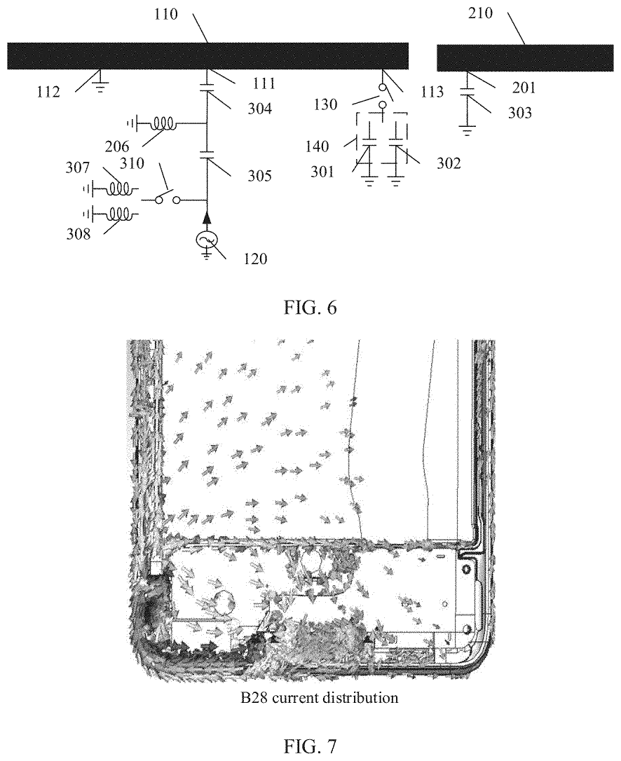

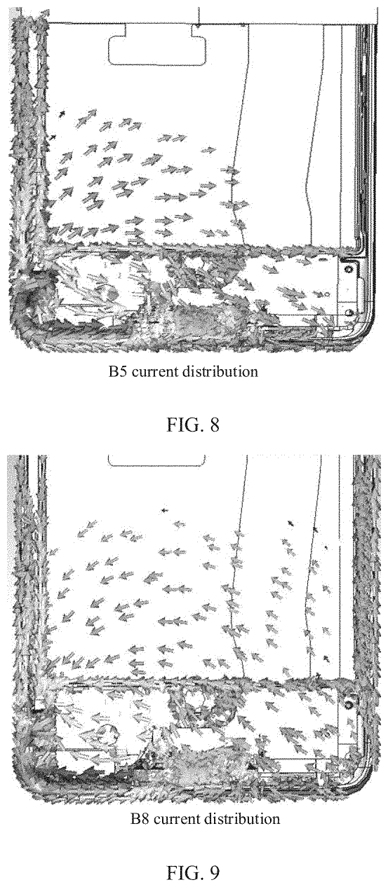

FIG. 7 to FIG. 9 are distribution diagrams of currents when a feed unit of the antenna structure shown in FIG. 4 is feeding. FIG. 7 is a distribution diagram of currents when an antenna structure works in a B28 frequency band. FIG. 8 is a distribution diagram of currents when an antenna structure works in a B5 frequency band. FIG. 9 is a distribution diagram of currents when an antenna structure works in a B8 frequency band.

As shown in FIG. 7 to FIG. 9, as a frequency changes from low to high, in a transverse mode and a longitudinal mode generated by the antenna structure, a proportion of the transverse mode increases. It should be understood that the longitudinal mode may be understood as that a current in the longitudinal mode is perpendicular to the bottom edge of the electronic device. The transverse mode may be understood as that a current in the transverse mode is parallel to the bottom edge of the electronic device.

When the antenna structure works in the longitudinal mode, a direction of maximum radiation of the antenna structure is parallel to the bottom edge of the electronic device. When a user uses a mobile phone, in a hand holding model, the maximum radiation of the antenna structure is absorbed by a hand, and a radiation performance loss of the antenna structure is large.

When the antenna structure works in the transverse mode, a direction of maximum radiation of the antenna structure is perpendicular to the bottom edge of the electronic device. When a user uses a mobile phone, in a hand holding model, maximum radiation of the antenna structure is not absorbed by a hand, and a radiation performance loss of the antenna structure is small, so that antenna radiation performance in a beside head and hand model can be effectively improved.

Optionally, the proportion of the transverse mode generated by the antenna structure may be adjusted by adjusting a location of the first radiator or a location of the feed point, and the transverse mode may be used to optimize antenna radiation performance in a beside head and hand model, to improve performance in free space.

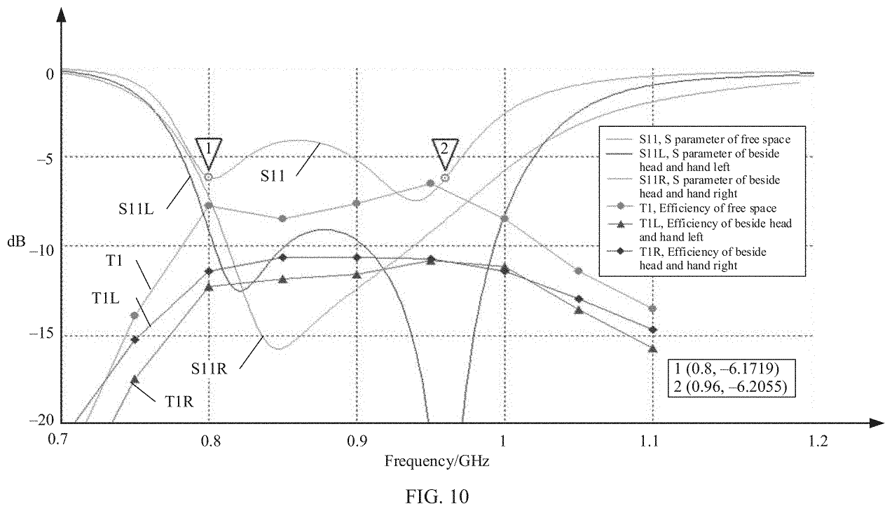

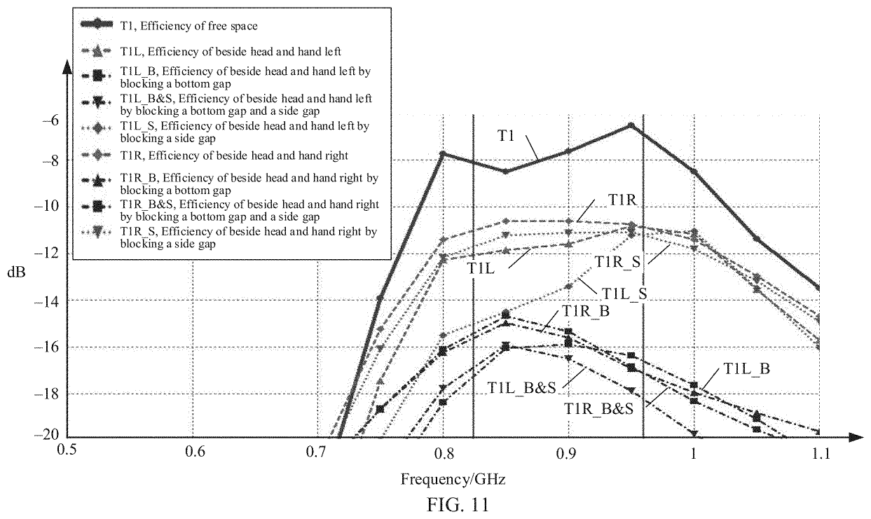

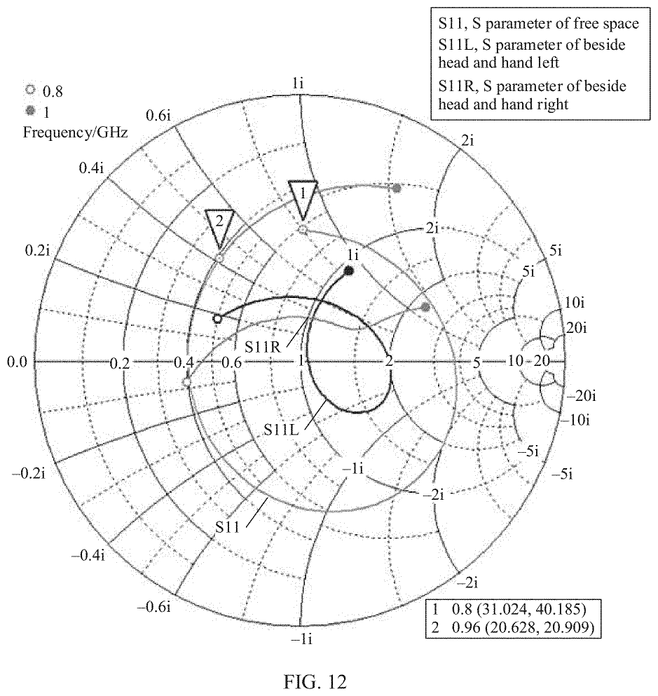

FIG. 10 and FIG. 11 are schematic simulation diagrams of system efficiency in a beside head and hand model according to an embodiment of this application. FIG. 10 and FIG. 11 are schematic diagrams of simulation results obtained when an operating frequency band of an antenna structure covers a B5 frequency band (824 MHz to 849 MHz) and a B8 frequency band (890 MHz to 915 MHz) in low frequency bands in an LTE system.

It should be understood that FIG. 10 shows system efficiency in free space, system efficiency in a beside head and hand left (beside head and hand left. BHHL) model, system efficiency in a beside head and hand right (beside head and hand right, BHHR) model, and corresponding S parameters that are of the antenna structure. Based on the system efficiency in FIG. 10, In FIG. 11, system efficiency in the beside head and hand left model obtained in the following cases is added: when the side gap is blocked, when the bottom gap is blocked, or when both the side gap and the bottom gap are blocked; and system efficiency in the beside head and hand right model obtained in the following cases is added: when the side gap is blocked, when the bottom gap is blocked, or when both the side gap and the bottom gap are blocked.

In addition, when the beside head and hand model blocks the bottom gap, a radiation characteristic of the antenna structure is changed. A resonance that is corresponding to the LTE system and that is covered by the antenna structure is generated by a radiator between a feed point and a first ground point. In this way, a significant decrease in radiation performance of the antenna structure caused by blocking the bottom gap can be effectively avoided.

As shown in FIG. 10, in the simulation result of the beside head and hand model, a decrease in the beside head and hand left/right model is about 3 dB to 4 dB.

As shown in FIG. 11, in the simulation result of the beside head and hand model, system efficiency in free space is about −8 dB, system efficiency in the beside head and hand left/right model is about −11 dB, system efficiency by blocking the side gap is about −11 dB/−13 dB, system efficiency by blocking the bottom gap is about −16 dB, and system efficiency by blocking both the side gap and the bottom gap is about −16 dB.

FIG. 12 is a Smith (Smith) chart in a beside head and hand model according to an embodiment of this application. FIG. 12 is a schematic diagram of simulation results obtained when an operating frequency band of an antenna structure covers a B5 frequency band (824 MHz to 849 MHz) and a B8 frequency band (890 MHz to 915 MHz) in low frequency bands in an LTE system.

As shown in FIG. 12, in free space, the operating frequency band of the antenna structure is distributed along a center. In a beside head and hand model, the operating frequency band of the antenna contracts to the center of the chart, and a frequency does not shift. This indicates good characteristics and meets actual production needs.

Table 1 shows a test result of total radiated power (total radiated power, TRP) of an antenna structure in a beside head and hand model according to an embodiment of this application.

TABLE 1

| | | | | BHHL | BHHR |
|---|---|---|---|---|---|
| Frequency | FS | BHHL | BHHR | decrease | decrease |
| band | (dB) | (dB) | (dB) | (dB) | (dB) |
| LTE B5 | 17.2 | 15.3 | 14.5 | 2.1 | 2.9 |
| | 17.1 | 15 | 14.1 | | |
| | 17.1 | 14.7 | 14 | | |
| LTE B8 | 17.2 | 14.4 | 14.2 | 3.2 | 3.4 |
| | 17.4 | 14.1 | 14 | | |
| | 17.5 | 13.9 | 13.6 | | |

According to the antenna structure provided in this embodiment of this application, a proportion of a transverse mode generated by the antenna structure may be controlled by adjusting a location of a feed point. As shown in Table 1, in the beside head and hand model, maximum radiation of the antenna structure is not absorbed, and a radiation performance loss of the antenna structure is small, so that antenna radiation performance in the beside head and hand model can be effectively improved.

The following Table 2 shows a TRP test result of an antenna structure obtained in a case in which a gap between the antenna structure and a frame is blocked by a real hand of a user according to an embodiment of this application.

TABLE 2

| Frequency | | | | | |
|---|---|---|---|---|---|
| band | Hand right (dB) | | | Hand left (dB) | |
| LTE B5 | A gap is | A side gap | A bottom gap | A gap is | A side gap |
| | not blocked | is blocked | is blocked | not blocked | is blocked |
| LTE B8 | 11.6 | 6.2 | 14.4 | 12.1 | 9.5 |

According to the antenna structure provided in this embodiment of this application, a location of a radiator that generates radiation may be changed based on different cases of hand holding by a user, to reduce impact of the hand holding by the user on radiation performance of the antenna structure. As shown in Table 2, performance is good.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual coupling or direct coupling or communication connections may be implemented through some interfaces. The indirect coupling or communication connections between the apparatuses or units may be implemented in electronic or other forms.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-11. (canceled)

12. An electronic device comprising:
a metal frame comprising two adjacent edges that form a junction area;
a first radiator disposed along the two adjacent edges, wherein the first radiator is part of the metal frame and comprises:
a first end;
a second end;
a feed point disposed in the junction area;
a first ground point located between the feed point and the first end;
a second ground point located between the feed point and the second end;
a feeding element coupled to the first radiator and configured to feed the first radiator at the feed point;
a matching network; and
a switch comprising:
a third end electrically coupled to the first radiator at the second ground point; and
a fourth end electrically coupled to the matching network.

13. The electronic device of claim 12, wherein the junction area is a chamfer of the two adjacent edges.

14. The electronic device of claim 12, wherein the junction area is an arc area of the two adjacent edges.

15. The electronic device of claim 12, wherein a distance between the feed point and the second ground point is a quarter of a wavelength corresponding to a resonance point of a resonance of the first radiator.

16. The electronic device of claim 12, wherein the feeding element is further configured to feed the first radiator at a frequency band corresponding to a resonance of the first radiator, and wherein the frequency band comprises a frequency range of 698 megahertz (MHz) to 960 MHz.

17. The electronic device of claim 16, wherein a length of the first radiator is greater than a quarter of a wavelength corresponding to a resonance point of the resonance and is less than a half of the wavelength.

18. The electronic device of claim 16, wherein the metal frame further comprises:
a side frame; and
a bottom frame,
wherein the first end is disposed on the side frame and is configured to form a side gap of the electronic device, and
wherein the second end is disposed on the bottom frame and is configured to form a bottom gap of the electronic device.

19. The electronic device of claim 18, wherein the resonance comprises a second resonance between the feed point and the second ground point when the first radiator is disposed in free space.

20. The electronic device of claim 18, wherein the resonance comprises a second resonance between the feed point and the first end when the first radiator is disposed beside head and hand mode.

21. The electronic device of claim 12, wherein the first radiator further comprises a central area, and wherein the feed point is located in the central area.

22. The electronic device of claim 21, wherein the feed point is located at a central position along a length of the first radiator.

23. The electronic device of claim 22, wherein a first electrical length between the feed point and the first ground point is equal to a second electrical length between the feed point and the second ground point.

24. The electronic device of claim 21, wherein a first electrical length of the first radiator on a first side of the feed point is equal to a second electrical length of the first radiator on a second side of the feed point.

25. The electronic device of claim 12, further comprising:
a second radiator disposed next to the first radiator; and
a gap formed between the second radiator and the first radiator.

26. The electronic device of claim 25, wherein the second radiator comprises:
a fifth end in proximity to the first radiator; and
a third ground point disposed on the fifth end, and
wherein the second radiator is grounded at the third ground point.

27. The electronic device of claim 26, further comprising a capacitor disposed between the third ground point and the first ground point, wherein the capacitor has a capacitance value of 1.6 picofarads (pF).

28. The electronic device of claim 25, further comprising a bottom gap, wherein the metal frame further comprises a bottom frame, wherein the second radiator is part of the bottom frame, and wherein the gap is the bottom gap.

29. The electronic device of claim 12, wherein the matching network comprises:
a first capacitor; and
a second capacitor,
wherein the switch is configured to switch between the first capacitor and the second capacitor to change an operating frequency of the first radiator.

30. The electronic device of claim 29, wherein the first capacitor has a first capacitance value of 1.5 picofarads (pF), and wherein the second capacitor has a second capacitance value of 0.5 pF.

31. The electronic device of claim 12, further comprising a second matching network disposed between the feeding element and the feed point.
